(19) United States
(12) Patent Application Publication
(10) Pub. No.: US 2023/0188574 A1
(43) Pub. Date: Jun. 15, 2023

(54) VOICE SERVICE HANDLING OF A UE IN A 5G SYSTEM

(71) Applicant: Telefonaktiebolaget LM Ericsson (publ), Stockholm (SE)

(72) Inventors: Ralf KELLER, Würselen (DE); Ann-Christine SANDER, Skepplanda (SE); Afshin ABTIN, Sollentuna (SE); David CASTELLANOS ZAMORA, Madrid (ES)

(73) Assignee: Telefonaktiebolaget LM Ericsson (publ), Stockholm (SE)

(21) Appl. No.: 17/925,822

(22) PCT Filed: Mar. 17, 2021
(86) PCT No.: PCT/EP2021/056816

§ 371 Date: Nov. 16, 2022

(30) Foreign Application Priority Data
May 18, 2020 (EP) 20382417.2

(51) Int. Cl. H04L 65/1016; H04L 65/1073; H04W 36/00

(52) U.S. Cl. CPC H04L 65/1016; H04L 65/1073; H04W 36/0022

(57) ABSTRACT

There is provided mechanisms for indicating IMS voice support over PS for a UE in a PLMN. A method is performed by an AMF of the PLMN. The method comprises obtaining a trigger for the AMF to indicate IMS voice support over PS for the UE in the PLMN. The method comprises obtaining information of IMS voice support over PS for the UE in the PLMN. The method comprises providing, based on the information, an indication to a radio access network serving the UE in the PLMN. The indication specifies the IMS voice support over PS for the UE in the PLMN.

### TECHNICAL FIELD

Embodiments presented herein relate to methods, an Access and Mobility Management Function (AMF), a Unified Data Manager (UDM), computer programs, and a computer program product for indicating Internet Protocol Multimedia Subsystem (IMS) voice support over Packet Switching (PS) for a User Equipment (UE) in a public land mobile network (PLMN).

### BACKGROUND

In general terms, a fifth generation (5G) system (5GS) is a telecommunication system using the 5G New Radio (NR) air interface, or the Evolved Universal Terrestrial

Radio Access (E-UTRA) air interface connected to a 5G core network (5GC). Support for voice services has recently been defined for 5GS. Voice services in 5GS can be supported either by means of Voice over NR (VoNR; also referred to as IMS Voice over NG-RAN, where NG-RAN is short for Next-Generation Radio Access Network) when voice services are supported in the UE, the radio network (i.e., the NR air interface) and the 5GC, or by means of Evolved Packet System (EPS) fallback when voice service are not supported in the radio network, not supported in the UE or not supported in the core network. VoNR and EPS fallback are defined in the documents 3GPP TS 23.501 entitled “System architecture for the 5G System (5GS)”, version 16.4.0, and 3GPP TS 23.502 entitled “Procedures for the 5G System (5GS)”, version 16.4.0, respectively.

EPS fallback implies that for a user equipment (UE) camping on a cell of a 5GS (NR/5GC) having an Internet Protocol Multimedia Subsystem (IMS) Protocol Data Unit (PDU) session established and IMS registration performed already, during an IMS call setup procedure (e.g. when a flow with Quality of service (QoS) with 5QI value equal to 1 is established, where ₅QI is short for 5G QoS Indicator), the network triggers a mobility procedure to move the UE from the 5GS to the EPS where the actual call will be established. During the EPS fallback procedure, the voice media bearer, a bearer with a QoS Class Identifier (QCI) with value 1 (i.e., QCI=1), will be established on the EPS.

For a voice centric UE to camp on a 5GS (5GC/NR), a Voice over PS (VoPS; where PS is short for Packet Switched) support indication provided from the network to the UE during registration with the 5GC is needed. This is specified in clause 5.16.3.5 of aforementioned 3GPP TS 23.501.

Additionally, for Voice over Long Term Evolution (VoLTE) and VoNR, the call of a UE with a voice session that moves to an area, tracking area, or network without VoPS support, should not be terminated because a bearer with QCI=1 (or a QoS flow with 5QI=1) has already been established in the network where the call set-up procedure originated. This is further explained in clause 7.2d in document 3GPP TS 23.221 entitled “Architectural requirements”, version 16.2.0, clause 5.5.3.2.4 in document 3GPP TS 24.301 entitled “Non-Access-Stratum (NAS) protocol for Evolved Packet System (EPS); Stage 3”, version 16.1.1, in relation to “Persistent EPS bearer context”, and clause 4.3.2 in document 3GPP TS 24.501 entitled “Non-Access-Stratum (NAS) protocol for 5G System (5GS); Stage 3”, version 16.1.0, in relation to “Persistent PDU session”. Persistent EPS bearer context implies that the UE has an established EPS bearer with QCI=1 (i.e. a voice call is about to be established or is already ongoing).

However, there might be scenarios for which the handling of voice services for the UE in a 5GS is not well defined. A consequence of this is that e.g., a call set-up procedure might be terminated.

Hence, there is still a need for an improved handling of voice services for a UE in a 5GS.

### SUMMARY

An object of embodiments herein is to provide efficient handling of voice services for a UE in a 5GS where the above note deficiencies are alleviated, mitigated, or reduced.

According to a first aspect there is presented a method for indicating IMS voice support over PS for a UE in a PLMN. The method is performed by an AMF of the PLMN. The method comprises obtaining a trigger for the AMF to indicate IMS voice support over PS for the UE in the PLMN. The method comprises obtaining information of IMS voice support over PS for the UE in the PLMN. The method comprises providing, based on the information, an indication to a radio access network serving the UE in the PLMN. The indication specifies the IMS voice support over PS for the UE in the PLMN.

According to a second aspect there is presented an AMF for indicating IMS voice support over PS for a UE in a PLMN. The AMF comprises processing circuitry. The processing circuitry being configured to cause the AMF to obtain a trigger for the

AMF to indicate IMS voice support over PS for the UE in the PLMN. The processing circuitry being configured to cause the AMF to obtain information of IMS voice support over PS for the UE in the PLMN. The processing circuitry being configured to cause the AMF to provide, based on the information, an indication to a radio access network serving the UE in the PLMN. The indication specifies the IMS voice support over PS for the UE in the PLMN.

According to a third aspect there is presented an AMF for indicating IMS voice support over PS for a UE in a PLMN. The AMF comprises an obtain module configured to obtain a trigger for the AMF to indicate IMS voice support over PS for the UE in the PLMN. The AMF comprises an obtain module configured to obtain information of IMS voice support over PS for the UE in the PLMN. The AMF comprises a provide module configured to provide, based on the information, an indication to a radio access network serving the UE in the PLMN. The indication specifies the IMS voice support over PS for the UE in the PLMN.

According to a fourth aspect there is presented a computer program for indicating IMS voice support over PS for a UE in a PLMN. The computer program comprises computer program code which, when run on processing circuitry of an AMF, causes the AMF to perform a method according to the first aspect.

According to a fifth aspect there is presented a method for enabling indicating IMS voice support over PS for a UE in a PLMN. The method is performed by a UDM of the PLMN. The method comprises obtaining a trigger from the AMF for the UDM to indicate IMS voice support over PS for the UE in the PLMN. The method comprises providing information to the AMF of IMS voice support over PS for the UE in the PLMN.

According to a sixth aspect there is presented a UDM for enabling indicating IMS voice support over PS for a UE in a PLMN. The UDM comprises processing circuitry.

The processing circuitry being configured to cause the UDM to obtain a trigger from the AMF for the UDM to indicate IMS voice support over PS for the UE in the PLMN. The processing circuitry being configured to cause the UDM to provide information to the AMF of IMS voice support over PS for the UE in the PLMN.

According to a seventh aspect there is presented a UDM for enabling indicating IMS voice support over PS for a UE in a PLMN. The UDM comprises an obtain module configured to obtain a trigger from the AMF for the UDM to indicate IMS voice support over PS for the UE in the PLMN. The UDM comprises a provide module configured to provide information to the AMF of IMS voice support over PS for the UE in the PLMN.

According to an eighth aspect there is presented a computer program for enabling indicating IMS voice support over PS for a UE in a PLMN. The computer program comprises computer program code which, when run on processing circuitry of a UDM, causes the UDM to perform a method according to the fifth aspect.

According to a ninth aspect there is presented a computer program product comprises a computer program according to at least one of the fourth aspect and the eighth aspect and a computer readable storage medium on which the computer program is stored. The computer readable storage medium could be a non-transitory computer readable storage medium.

Advantageously, these aspects provide efficient handling of voice services for a UE in a 5GS without suffering from the above noted issues.

Advantageously, these aspects allow the HPLMN and VPLMN to control whether to use EPS Fallback or VoNR for an inbound roaming UE, avoiding call failures due to incompatible capabilities in the HPLMN and the VPLMN.

Advantageously, these aspects enable the HPLMN to have the option to differentiate 5GS subscriptions by enabling only EPS Fallback for some subscribers. Advantageously, this is applicable regardless if the UE is roaming or not.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, action, etc.” are to be interpreted openly as referring to at least one instance of the element, apparatus, component, means, module, action, etc., unless explicitly stated otherwise. The actions of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2 and 3 are flowcharts of methods according to embodiments;

FIGS. 4 and 5 are signalling diagrams according to embodiments;

FIG. 6 is a schematic diagram showing functional units of an AMF according to an embodiment;

FIG. 7 is a schematic diagram showing functional modules of an AMF according to an embodiment;

FIG. 8 is a schematic diagram showing functional units of a UDM according to an embodiment;

FIG. 9 is a schematic diagram showing functional modules of a UDM according to an embodiment;

FIG. 10 shows one example of a computer program product comprising computer readable means according to an embodiment;

FIG. 11 depicts a wireless network;

FIG. 12 is a schematic diagram illustrating a telecommunication network connected via an intermediate network to a host computer in accordance with some embodiments; and

FIG. 13 is a schematic diagram illustrating host computer communicating via a network node with a UE over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any action or feature illustrated by dashed lines should be regarded as optional.

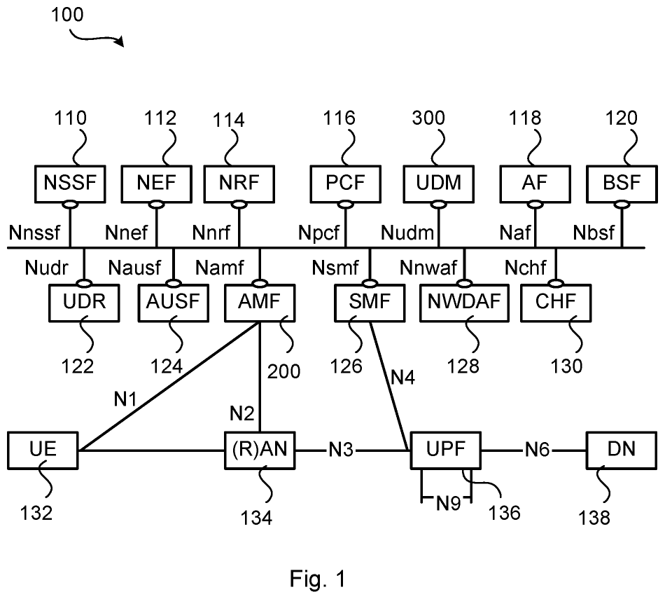

FIG. 1 is a schematic diagram illustrating a communication network 100 where embodiments presented herein can be applied. The communication network 100 might be regarded as a PLMN and represents a reference architecture of a fifth generation telecommunication system (5GS) and comprises the following entities: an Authentication Server Function (AUSF) 124, an Access and Mobility Management Function (AMF) 200, a Data Network (DN) 138, e.g. operator services, Internet access or 3rd party services, a Network Exposure Function (NEF) 112, a Network Repository Function (NRF) 114, a Network Slice Selection Function (NSSF) 110, a Policy Control Function (PCF) 116, a Session Management Function (SMF) 126, a Unified Data Manager (UDM) 300, a Unified Data Repository (UDR) 122, a User Plane Function (UPF) 136, an Application Function (AF) 118, a User Equipment (UE) 132, a (Radio) Access Network ((R)AN) 134, a Network Data Analytics Function (NWDAF) 128, a Binding Support Function (BSF) 120, and a Charging Function (CHF) 130. Service based interfaces are represented by the format Nxyz (e.g., Nnssf, Nnef, etc.) and point to point interfaces are represented by the format Nx (e.g. N1, N2, etc.). As the skilled person understands, for a scenario where the UE 132 is roaming, some of the entities of FIG. 1 are part of the home public land mobile network (HPLMN) of the UE 132 whereas some entities (i.e., those not part of the HPLMN) of FIG. 1 are part of the visited public land mobile network (VPLMN) of the UE 132.

As disclosed above there is still a need for an improved handling of voice services for a UE 132 in a 5GS.

Assume for illustrative purposes that the UE belongs to a HPLMN but is roaming in the VPLMN. As an example, if both the HPLMN and the VPLMN have the same capabilities, i.e., both the HPLMN and the VPLMN support EPS Fallback or both the HPLMN and the VPLMN support VoNR, then there is no need for additional information between the HPLMN and the VPLMN. This is applicable also the case when the HPLMN supports both EPS Fallback and VoNR but the VPLMN supports only EPS Fallback or only VoNR. Table 1 summarizes the supported combinations of EPS Fallback and VoNR.

TABLE 1
Combination of supported alternatives
for voice calls in NR environments

| | VPLMN | | |
|---|---|---|---|
| HPLMN | EPS FB and VoNR | EPS FB only | VoNR only |
| EPS FB and VoNR | EPS FB and VoNR | EPS FB only | VoNR only |
| EPS FB only | EPS FB only | EPS FB only | (No support) |
| VoNR only | VoNR only | (No support) | VoNR only |

From Table 1 thus follows that if the HPLMN supports only VoNR but the VPLMN supports only EPS Fallback, then any inbound roamer to the VPLMN from the HPLMN will be subject of EPS Fallback, which is not supported by HPLMN. In the same way, if the HPLMN supports only EPS Fallback but the VPLMN supports only VoNR, then any inbound roamer to the VPLMN from the HPLMN will be subject of VoNR, which is not supported by HPLMN. Further, the HPLMN cannot control whether EPS Fallback or VoNR is to be used in the VPLMN if both are supported in the VPLMN, but the mobile network operator of the HPLMN wants different support for different subscriber groups. Additionally, in non-roaming cases, a mobile network operator might prefer to provide different subscription types where certain subscription types rely mainly based on EPS Fallback for voice services and others on VoNR for voice services, but where all subscription types use the 5GS for data.

The embodiments disclosed herein therefore relate to mechanisms for indicating, and enabling indicating, IMS voice support over PS for a UE 132 in a PLMN 100. In order to obtain such mechanisms there is provided an AMF 200, a method performed by the AMF 200, a computer program product comprising code, for example in the form of a computer program, that when run on processing circuitry of the AMF 200, causes the AMF 200 to perform the method. In order to obtain such mechanisms there is further provided a UDM 300, a method performed by the UDM 300, and a computer program product comprising code, for example in the form of a computer program, that when run on processing circuitry of the UDM 300, causes the UDM 300 to perform the method.

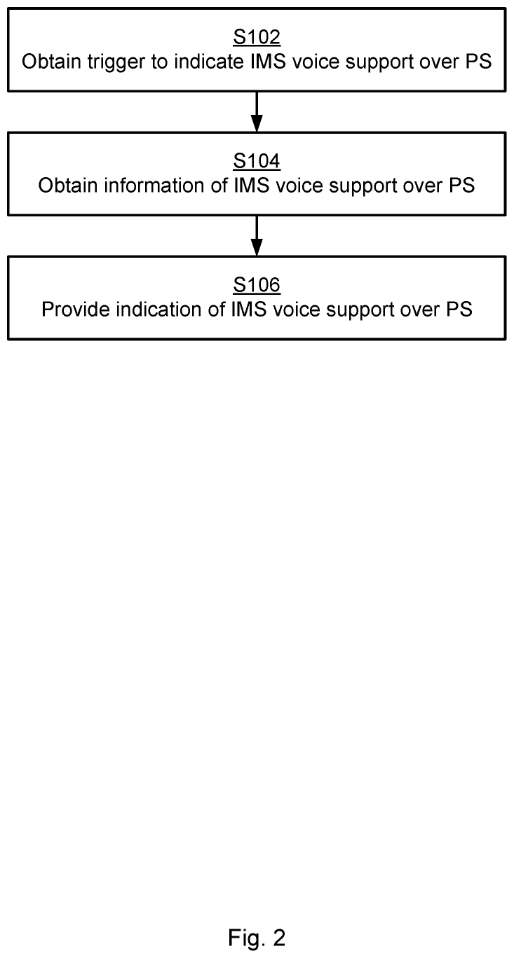

Reference is now made to FIG. 2 illustrating a method for indicating IMS voice support over PS for a UE 132 in a PLMN 100 as performed by the AMF 200 according to an embodiment.

S102: The AMF 200 obtains a trigger for the AMF 200 to indicate IMS voice support over PS for the UE 132 in the PLMN 100.

S104: The AMF 200 obtains information of IMS voice support over PS for the UE 132 in the PLMN 100.

In this respect, either of action S102 and action S104 might be performed first. Aspects relating to the internal order in which these actions are performed will be disclosed below. Action S106 is performed when both action S102 and action S104 have been performed.

S106: The AMF 200 provides, based on the information, an indication to a radio access network 134 serving the UE 132 in the PLMN 100, wherein the indication specifies the IMS voice support over PS for the UE 132 in the PLMN 100.

The indication as provided in action S106 might change over time in case the information as obtained in action S104 changes. Hence, action S106 might be executed again once new information is obtained in action S104.

Embodiments relating to further details of indicating IMS voice support over PS for a UE 132 in a PLMN 100 as performed by the AMF 200 will now be disclosed.

Aspects of when the trigger in S102 might be obtained will now be disclosed. In some aspects the trigger is obtained during network registration of the UE 132. That is, in some embodiments, the trigger is a registration request message obtained from the radio access network 134 during network registration of the UE 132. In other aspects, the trigger is obtained during a PDU session modification procedure of the UE 132. That is, in some embodiments the trigger is a Namf_Communication_N1N2Message_Transfer message obtained from an SMF during a PDU session modification procedure for the UE 132.

Aspects of the indication as provided in S106 will now be disclosed. The information of IMS voice support over PS for the UE 132 in the PLMN 100 might relate to whether EPS fallback and/or VoNR is supported for the UE 132 in the PLMN 100. That is, in some embodiments, according to the information, at least one of EPS fallback and VoNR is supported for the UE 132 in the PLMN 100. Further, the indication might even specify that neither EPS fallback nor VoNR is supported for the UE 132 in the PLMN 100. The latter could be a possible value for a HPLMN of the UE 132 to exclude voice support for an outbound roaming UE 132.

Aspects of how the information in action S104 might be obtained will now be disclosed. In some aspects, the information is in action S104 obtained from a UDM 300. In this respect, the information might be obtained from the UDM 300 upon the AMF 200 having provided a Nudm_SDM_Get request message to the UDM 300. In some embodiments, the information is obtained as Access and Mobility Subscription data in a Nudm_SDM_Get response message from the UDM 300. In other embodiments, the information is obtained as SMF Selection Subscription Data in a Nudm_SDM_Get response message from the UDM 300. The subscriber data in the UDM 300 at the HPLMN might thus comprise information to an AMF 200 in the VPLMN about the type of IMS voice support in the 5GS for the UE 132, at least to indicate that only EPS Fallback should be used (e.g. when only EPS Fallback is supported in the HPLMN), or that either EPS Fallback, VoNR, or both can be used. In yet other embodiments, the information is obtained from the UDM 300 by the UDM 300 not including an IMS DNN in a list of subscribed DNNs that is provided to the AMF 200. The UDM 300 may thereby implicitly indicate to an AMF 200 of a VPLMN that voice support for an outbound roaming UE 132 is not allowed by not including the IMS DNN in the list of subscribed DNN to the AMF 200.

In some aspects, the information is in action S104 not obtained from the UDM 300. For example, the information might be based on information of its own subscribers. In particular, in some embodiments, the information is obtained as configuration from a memory of the AMF 200 where the configuration is defined by information. For example, the information might be based on a roaming agreement (between two PLMNs). In particular, in some embodiments, the information is obtained as configuration from a memory of the AMF 200 where the configuration is defined by roaming agreement information. In this respect, the AMF 200 might be configured with information regarding which PLMNs are subject to apply EPS Fallback, VoNR or both for an inbound roaming UE 132. One example of this is where the VPLMN supports provisioning of an indication “IMS VoPS (Support Indicator)=supported” from the AMF 200 to the UE 132 if the VPMN has a roaming agreement that covers support of IMS voice with the HPMN as specified in subclause 5.16.3.2 of aforementioned document 3GPP TS 23.501. The “IMS VoPS” indicator can reflect the roaming agreement which is intended to support IMS voice only in EPS, while excluding the case of IMS voice via NR connected to 5GC. Further aspects of how the configuration might be provided will now be disclosed. In some examples, the configuration is provided as a list of PLMNs 100 subject to apply EPS fallback and/or a list of PLMNs 100 subject to apply VoNR. In some examples, the configuration is provided as a list of international mobile subscriber identity (IMSI) series of PLMNs 100 subject to apply EPS fallback and/or a list of IMSI series of PLMNs 100 subject to apply VoNR. The AMF 200 might thus be configured with IMSI series of which specific PLMNs that are to use EPS Fallback, VoNR, or both. In this respect, the IMSI might not be the complete IMSI but the PLMN-id consisting only of the mobile network code (MNC) part and/or the mobile country code (MCC) part of the IMSI.

In case the information in action S104 is obtained both from the UDM 300 and as configuration and there is a conflict between the information obtained from the UDM 300 and the configuration, the configuration might take precedence.

Aspects of the internal order between actions S102 and S104 will now be disclosed. In some aspects, the AMF 200 obtains the information upon having obtained the trigger. That is, in some embodiments, the trigger causes the AMF 200 to obtain the information. Thus, in such scenarios, action S102 is performed before action S104. This could be the case when the trigger is obtained during network registration of the UE 132. In some aspects, the AMF 200 already has the information when obtaining the trigger in S102. That is, in some embodiments, the AMF 200 obtains the information before obtaining the trigger. Thus, in such scenarios, action S104 is performed before action S102. This could be the case when the trigger is obtained during a PDU session modification procedure of the UE 132.

Aspects of the indication as provided in S106 will now be disclosed. As disclosed above, the trigger might be obtained during network registration of the UE 132. In this respect, the indication might in action S106 also be provided during network registration of the UE 132. That is, in some embodiments, the indication is provided to the radio access network 134 in a registration accept message during network registration of the UE 132. As disclosed above, the trigger might be obtained during a PDU session modification procedure of the UE 132. In this respect, the indication might in action S106 also be provided during the same PDU session modification procedure of the UE 132. That is, in some embodiments, the indication is provided to the radio access network 134 in an N2 message during a PDU session modification procedure for the UE 132.

Further aspects of the indication as provided in S106 will now be disclosed. As disclosed above, the information of IMS voice support over PS for the UE 132 in the PLMN 100 might relate to whether EPS fallback and/or VoNR is supported for the UE 132 in the PLMN 100. Therefore, in some embodiments, the indication only specifies whether EPS fallback is supported or not for the UE 132 in the PLMN 100. In some embodiments, the indication specifies whether VoNR is supported or not for the UE 132 in the PLMN 100. In some embodiments, the indication specifies that neither EPS fallback nor VoNR is supported for the UE 132 in the PLMN 100.

Aspects of the PLMN 100 will now be disclosed. The PLMN 100 light either be the home PLMN of the UE 132 or a visited PLMN of the UE 132, depending on whether the UE 132 is roaming or not. In a first example, the PLMN 100 is a visited PLMN of the UE 132. This is the case where the UE 132 is roaming. In a second example, the PLMN 100 is the home PLMN of the UE 132. This is the case where the UE 132 is not roaming. Thus, the herein disclosed embodiments are applicable to all types of subscribers; both home subscribers and roaming subscribers.

Reference is now made to FIG. 3 illustrating a method for enabling indicating IMS voice support over PS for a UE 132 in a PLMN 100 as performed by the UDM 300 according to an embodiment.

S202: The UDM 300 obtains a trigger from the AMF 200 for the UDM 300 to indicate IMS voice support over PS for the UE 132 in the PLMN 100; and

S104: The UDM 300 provides information to the AMF 200 of IMS voice support over PS for the UE 132 in the PLMN 100.

Embodiments relating to further details of enabling indicating IMS voice support over PS for a UE 132 in a PLMN 100 as performed by the UDM 300 will now be disclosed.

In general terms, the embodiment as disclosed above for the AMF 200 are applicable also for the UDM 300.

As disclosed above, the information of IMS voice support over PS for the UE 132 in the PLMN 100 might be obtained by the AMF 200 from the UDM 300 upon the AMF 200 having provided a Nudm_SDM_Get request message to the UDM 300. Therefore, in some embodiments, the trigger is obtained in a Nudm_SDM_Get request message from the AMF 200.

As disclosed above, the information might be provided as Access and Mobility Subscription data in a Nudm_SDM_Get response message to the AMF 200. As also disclosed above, the information might be provided as SMF Selection Subscription Data in a Nudm_SDM_Get response message to the AMF 200.

As disclosed above, the information might be provided by the UDM 300 not including an IMS DNN in a list of subscribed DNNs to the AMF 200.

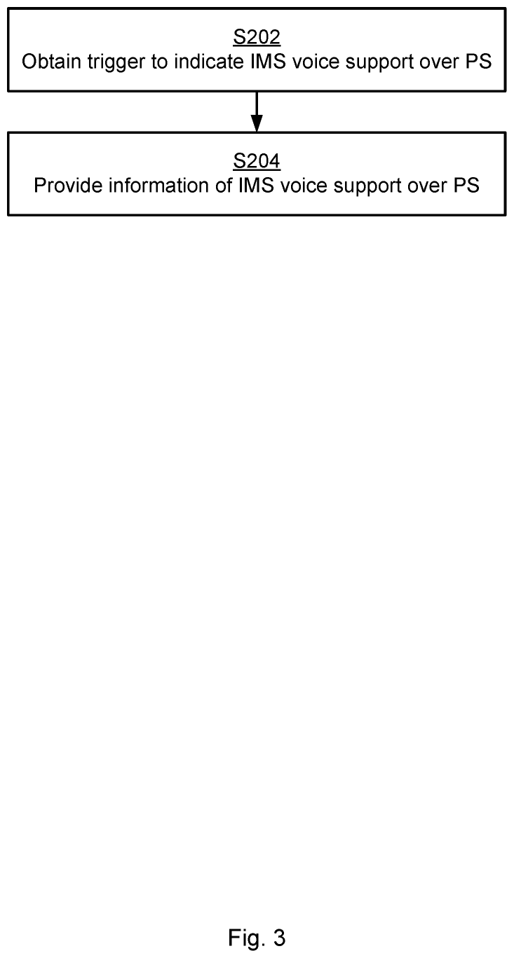

A first particular embodiment for indicating IMS voice support over PS for a UE 132 in a PLMN 100 based on at least some of the above disclosed embodiments will now be disclosed in detail with reference to the signalling diagram of FIG. 4 (where EIR is short for Equipment Identity Register).

The serving PLMN AMF sends an indication toward the UE during the Registration procedure over 3GPP access to indicate if an IMS voice over PS session is supported or not supported in 3GPP access and non-3GPP access. A UE with “IMS voice over PS” voice capability over 3GPP access should take this indication into account when performing voice domain selection, as described in clause 5.16.3.5 of aforementioned document 3GPP TS 23.501.

The serving PLMN AMF may only indicate IMS voice over PS session supported over 3GPP access in one of the following cases:

If the network and the UE are able to support IMS voice over PS session in the current Registration Area with a 5G QoS Flow that supports voice as specified in clause 5.7 of aforementioned document 3GPP TS 23.501.

If the network or the UE are not able to support IMS voice over PS session over NR connected to 5GC, but is able for one of the following: if the network and the UE are able to support IMS voice over PS session over E-UTRA connected to 5GC, and the NG-RAN supports a handover or redirection to E-UTRA connected to 5GC for this UE at QoS Flow establishment for IMS voice; if the UE supports handover to EPS, the EPS supports IMS voice, and the NG-RAN supports a handover to EPS for this UE at QoS Flow establishment for IMS voice; or if the UE supports redirection to EPS, the EPS supports IMS voice, and the NG-RAN supports redirection to EPS for this UE at QoS Flow establishment for IMS voice.

If the network is not able to provide a successful IMS voice over PS session over E-UTRA connected to 5GC, but is able for one of the following: if the UE supports handover to EPS, the EPS supports IMS voice, and the NG-RAN supports a handover to EPS for this UE at QoS Flow establishment for IMS voice; or if the UE supports redirection to EPS, the EPS supports IMS voice, and the NG-RAN supports redirection to EPS for this UE at QoS Flow establishment for IMS voice.

The serving PLMN provides this indication based e.g. on local policy, UE capabilities, HPLMN, whether IP address preservation is possible, whether NG-RAN to UTRAN SRVCC is supported and how extended NG-RAN coverage is, the IMS over 5GS Voice solution indication from the UDM or as provided by the roaming agreement, and the Voice Support Match Indicator from the NG-RAN (see clause 4.2.8a of aforementioned document 3GPP TS 23.502). The AMF in the serving PLMN might indicate that IMS voice over PS is supported only if the serving PLMN has a roaming agreement that covers support of IMS voice with the HPLMN and the serving PLMN supports the IMS Voice type (EPS Fallback, IMS Voice over NG-RAN (or IMS voice over NR, to be decided by 3GPP), both EPS Fallback and IMS Voice over NG-RAN) for the inbound roamer UE as indicated by the UDM or as provided by the roaming agreement. This indication is per Registration Area.

If the network supports EPS fallback for voice the 5GC can be configured not to perform the Voice Support Match Indicator procedure in order to set the IMS voice over PS session Supported Indication.

Action 1: The UE sends registration request message to the (R)AN. The registration request might be an AN message as specified in aforementioned document 3GPP TS 23.501.

Action 2: The (R)AN selects an AMF. As specified in aforementioned document 3GPP TS 23.501, this could be the case if a 5G-S-TMSI (Serving Temporary Mobile Subscriber Identity) or GUAMI (Globally Unique AMF ID) is not included in the registration request message or the 5G-S-TMSI or GUAMI does not indicate a valid AMF the (R)AN, based on (R)AT and Requested Network Slice Selection Assistance Information (NSSAI), if available. The AMF could be selected as described in clause 6.3.5 of aforementioned document 3GPP TS 23.501. If UE is in CM-CONNECTED state, the (R)AN can forward the Registration Request message to the AMF based on the N2 connection of the UE. If the (R)AN cannot select an appropriate AMF, it forwards the Registration Request to an AMF which has been configured, in (R)AN, to perform AMF selection.

Action 3: The (R)AN forwards the registration request as received in action 1 to the new AMF. As specified in aforementioned document 3GPP TS 23.501, the registration request could be forwarded in an N2 message (comprising N2 parameters, Registration Request (as described in action 1) and [LTE-M Indication]).

If the new AMF has already received UE contexts from the old AMF during handover procedure, then below action 4, 5 and 10 might be skipped.

Action 4: The new AMF sends a Namf_Communication_UEContextTransfer (complete Registration Request) message to the old AMF.

Action 5: The old AMF sends a Response to the Namf_Communication_UEContextTransfer (SUPI, UE Context in AMF) or UDSF to the new AMF, where SUPI is short for Subscription Permanent Identifier.

Action 6: The new AMF send an Identity Request ( ) to the UE.

Action 7: The UE responds with an Identity Response message including the SUCI to the new AMF, where SUCI is short for Subscription Concealed Identifier; an encrypted version of the SUPI.

Action 8: The AMF may decide to initiate UE authentication by invoking an AUSF. In that case, the AMF might select an AUSF based on SUPI or SUCI, as described in clause 6.3.4 of aforementioned document 3GPP TS 23.501.

Action 9a: If authentication is required, the AMF requests authentication from the AUSF; if Tracing Requirements about the UE are available at the AMF, the AMF provides Tracing Requirements in its request to AUSF. Upon request from the AMF, the AUSF executes authentication of the UE. The AUSF might select a UDM as described in clause 6.3.8 of aforementioned document 3GPP TS 23.501 and get the authentication data from UDM.

Action 9b: If a NAS security context does not exist, NAS security initiation might be performed. If the UE had no NAS security context in action 1, the UE includes the full Registration Request message. The AMF decides if the Registration Request needs to be rerouted.

Action 9c: The AMF initiates a NGAP procedure to provide the 5G-AN with security context if the 5G-AN had requested for UE Context. Also, if the AMF does not support N26 for EPS interworking and it received UE MM Core Network Capability including an indication that it supports Request Type flag “handover” for PDN connectivity request during the attach procedure, the AMF provides an indication “Redirection for EPS fallback for voice is possible” towards the 5G-AN. In this respect, if the AMF 200 has indicated that “Redirection for EPS fallback for voice is not possible”, then EPS fallback for IMS voice is not performed. If the NG-RAN has not received the indication “Redirection for EPS fallback for voice” (either possible or not possible), the decision to execute EPS fallback for IMS voice or not is based on network configuration (e.g. instead based on N26 availability and/or other criteria). In addition, if Tracing Requirements about the UE are available at the AMF, the AMF provides the 5G-AN with Tracing Requirements in the NGAP procedure.

Action 9d: The 5G-AN stores the security context and acknowledges to the AMF. The 5G-AN uses the security context to protect the messages exchanged with the UE.

Action 10: The new AMF sends a Namf_Communication_RegistrationCompleteNotify (PDU Session ID(s) to be released due to slice not supported) message to the old AMF.

Action 11: The new AMF sends an Identity Request/Response (PEI) to the UE.

Action 12 (Optional): The new AMF initiates ME identity check by invoking the N5g-eir_EquipmentIdentityCheck_Get service operation (for example as in clause 5.2.4.2.2 of aforementioned document 3GPP TS 23.501).

Action 13: The new AMF, based on the SUPI, selects a UDM, then UDM may select a UDR instance, for example as in clause 6.3.9 of aforementioned document 3GPP TS 23.501. The AMF selects a UDM, for example as described in clause 6.3.8 of aforementioned document 3GPP TS 23.501.

Actions 14a-c: If the AMF has changed since the last Registration procedure, or if the UE provides a SUPI which does not refer to a valid context in the AMF, or if the UE registers to the same AMF it has already registered to a non-3GPP access (i.e. the UE is registered over a non-3GPP access and initiates this Registration procedure to add a 3GPP access), the new AMF registers with the UDM using Nudm_UECM_Registration for the access to be registered (and subscribes to be notified when the UDM deregisters this AMF).

If the AMF does not have subscription data for the UE, the AMF retrieves the Access and Mobility Subscription data, SMF Selection Subscription data, UE context in SMF data and LCS mobile origination using Nudm_SDM_Get. If the AMF already has subscription data for the UE but the SoR Update Indicator in the UE context requires the AMF to retrieve SoR information depending on the NAS Registration Type (“Initial Registration” or “Emergency Registration”), the AMF retrieves the Steering of Roaming information using Nudm_SDM_Get. This requires that UDM may retrieve this information from UDR by Nudr_DM_Query. After a successful response is received, the AMF subscribes to be notified using Nudm_SDM_Subscribe when the data requested is modified, UDM may subscribe to UDR by Nudr_DM_Subscribe. The GPSI (short for general public subscription identifier) is provided to the AMF in the Access and Mobility Subscription data from the UDM if the GPSI is available in the UE subscription data. As disclosed above, in some embodiment, the information of IMS voice support over PS for the UE 132 in the PLMN 100 is provided to the AMF 200 as Access and Mobility Subscription data or as SMF Selection Subscription Data associated with IMS DNN configuration.

The UDM may provide an indication that the subscription data for network slicing is updated for the UE. If the UE is subscribed to MPS in the serving PLMN, “MPS priority” is included in the Access and Mobility Subscription data provided to the AMF. If the UE is subscribed to mission critical services (MCX) in the serving PLMN, “MCX priority” is included in the Access and Mobility Subscription data provided to the AMF. The UDM also provides the IAB-Operation allowed indication to AMF as part of the Access and Mobility Subscription data. The AMF might trigger the setup of the UE context in NG-RAN, or modification of the UE context in NG-RAN if the initial setup is at action 9c, including an indication that the IAB node is authorized.

Action 14d: When the UDM stores the associated Access Type (e.g. 3GPP) together with the serving AMF as indicated in action 14a, this might cause the UDM to initiate a Nudm_UECM_DeregistrationNotification (see clause 5.2.3.2.2 of aforementioned document 3GPP TS 23.501) to the old AMF corresponding to the same (e.g. 3GPP) access, if one exists.

Action 14e: If old AMF does not have UE context for another access type (i.e. non-3GPP access), the Old AMF unsubscribes with the UDM for subscription data using Nudm_SDM_unsubscribe.

Action 15: If the AMF decides to initiate PCF communication, the AMF acts as follows. If the new AMF decides to use the (V-)PCF identified by the (V-)PCF ID included in UE context from the old AMF in action 5, the AMF contacts the (V-)PCF identified by the (V-)PCF ID to obtain the policy. If the AMF decides to perform PCF discovery and selection and the AMF selects a (V)-PCF and may select an H-PCF (for roaming scenario), for example as described in clause 6.3.7.1 of aforementioned document 3GPP TS 23.501 and according to the V-NRF to H-NRF interaction described in clause 4.3.2.2.3.3 of aforementioned document 3GPP TS 23.501.

Action 16: The new AMF performs AM Policy Association Establishment/Modification. For an Emergency Registration, this action is skipped.

Action 17: The AMF sends a Nsmf_PDUSession_UpdateSMContext ( ) message to SMF.

Action 18: If the new AMF and the old AMF are in the same PLMN, the new AMF sends a UE Context Modification Request to N3IWF/TNGF/W-AGF.

Action 19: the N3IWF/TNGF/W-AGF sends a UE Context Modification Response to the new AMF.

Action 19a: After the new AMF receives the response message from the N3IWF, W-AGF or TNGF in action 19, the new AMF registers with the UDM using Nudm_UECM_Registration as action 14a, but with the Access Type set to “non-3GPP access”. The UDM stores the associated Access Type together with the serving AMF and does not remove the AMF identity associated to the other Access Type if any. The UDM may store in UDR information provided at the AMF registration by Nudr_DM_Update.

Action 19b: When the UDM stores the associated Access Type (i.e. non-3GPP) together with the serving AMF as indicated in action 19a, it will cause the UDM to initiate a Nudm_UECM_DeregistrationNotification (see clause 5.2.3.2.2) to the old AMF corresponding to the same (i.e. non-3GPP) access. The old AMF removes the UE context for non-3GPP access.

Action 19c: The Old AMF unsubscribes with the UDM for subscription data using Nudm_SDM_unsubscribe.

Action 20: (not used)

Action 21: The new AMF sends a Registration Accept message to the UE. The registration accept message might be a registration accept message as specified in aforementioned document 3GPP TS 23.501. As disclosed above, the registration Accept message might comprise the indication that specifies the IMS voice support over PS for the UE 132 in the PLMN 100. In this respect, the indication might only contain the IMS voice type, or types supported for this UE 132, e.g. EPS Fallback, VoNR, or both EPS Fallback and VoNR.

Further, in case that the serving PLMN does not have a roaming agreement that covers support of IMS voice support over PS with the HPLMN or the serving PLMN does not support the IMS voice type (EPS Fallback, VoNR, or both EPS Fallback and VoNR) for the inbound roaming UE as indicated by the UDM or as provided by the roaming agreement, the AMF might indicate that IMS voice over PS is not supported for the UE.

Action 21b: The new AMF performs a UE Policy Association Establishment. The UE

Policy Association Establishment might be performed as defined in clause 4.16.11 of aforementioned document 3GPP TS 23.501. For an Emergency Registration, this action is skipped. The new AMF sends a Npcf_UEPolicyControl Create Request to PCF. PCF sends a Npcf_UEPolicyControl Create Response to the new AMF. PCF triggers UE Configuration Update Procedure, for example as defined in clause 4.2.4.3 of aforementioned document 3GPP TS 23.501.

Action 22: The UE sends a Registration Complete ( ) message to new AMF. The UE might send a Registration Complete message to the AMF when the UE has successfully updated itself after receiving any of the [Configured NSSAI for the Serving PLMN], [Mapping Of Configured NSSAI] and a Network Slicing Subscription Change Indication in action 21. The UE sends a Registration Complete message to the AMF to acknowledge if a new 5G-GUTI was assigned.

Action 23: If the Access and Mobility Subscription data provided by UDM to AMF in action 14b includes Steering of Roaming information with an indication that the UDM requests an acknowledgement of the reception of this information from the UE, the AMF provides the UE acknowledgement to UDM using Nudm_SDM_Info.

Action 23a: For Registration over 3GPP Access, if the AMF does not release the signalling connection, the AMF sends the RRC Inactive Assistance Information to the NG-RAN. For Registration over non-3GPP Access, if the UE is also in CM-CONNECTED state on 3GPP access, the AMF sends the RRC Inactive Assistance Information to the NG-RAN. The AMF also uses the Nudm_SDM_Info service operation to provide an acknowledgment to UDM that the UE received the Network Slicing Subscription Change Indication and acted upon it.

Action 24: After action 14a, and in parallel to any of the preceding actions, the AMF might send a “Homogeneous Support of IMS Voice over PS Sessions” indication to the UDM using Nudm_UECM_Update. If the AMF has evaluated the support of IMS Voice over PS Sessions, see clause 5.16.3.2 of aforementioned document 3GPP TS 23.501, and if the AMF determines that it needs to update the Homogeneous Support of IMS Voice over PS Sessions, see clause 5.16.3.3 of aforementioned document 3GPP TS 23.501.

Action 25: If the UE indicates its support for Network Slice-Specific Authentication and Authorization procedure in the UE MM Core Network Capability in Registration Request, and any S-NSSAI of the HPLMN is subject to Network Slice-Specific Authentication and Authorization, the related procedure is executed at this action. Once the Network Slice-Specific Authentication and Authorization procedure is completed for all S-NSSAIs, the AMF might trigger a UE Configuration Update procedure to deliver an Allowed NSSAI containing also the S-NSSAIs for which the Network Slice-Specific Authentication and Authorization was successful, and include any rejected NSSAIs with an appropriate rejection cause value.

A second particular embodiment for indicating IMS voice support over PS for a UE 132 in a PLMN 100 based on at least some of the above disclosed embodiments will now be disclosed in detail with reference to the signalling diagram of FIG. 5.

During a voice call setup (either mobile originating (i.e., originating from UE 132) or mobile terminating (i.e., destined to UE 132)), the SIP procedures for call setup starts on an already-established IMS PDU session. The SIP signaling will result in interaction from the IMS via PCF to the 5GC in order to create an additional QoS flow for audio using a PDU session modification procedure. This procedure is started in below action 1b (action 1b is started by IMS interaction towards the PCF as for any IMS call).

In the procedure of the signalling diagram of FIG. 5, it is assumed that the AMF 200 already has obtained the information of IMS voice support over PS for the UE 132 in the PLMN 100 (either during network registration of the UE 132 or per configuration). An indication that specifies the IMS voice support over PS for the UE 132 in the PLMN 100 is then provided in the N2 message to the (R)AN of below action 4.

Action 1a: The UE initiates the PDU Session Modification procedure by the transmission of an NAS message. The NAS message might be specified as in aforementioned document 3GPP TS 23.502.

Action 1b: The PCF performs a PCF initiated SM Policy Association Modification procedure. The SM Policy Association Modification procedure might be defined as in clause 4.16.5.2 of aforementioned document 3GPP TS 23.502.

Action 1c: The UDM updates the subscription data of SMF by Nudm_SDM_Notification (SUPI, Session Management Subscription Data). The SMF updates the Session Management Subscription Data and acknowledges the UDM by returning an Ack with (SUPI).

Action 1d: The SMF may decide to modify PDU Session. This procedure also may be triggered based on locally configured policy or triggered from the (R)AN. It may also be triggered if the UP connection is activated and the SMF has marked that the status of one or more QoS Flows are deleted in the 5GC but not synchronized with the UE yet.

Action 1e. The (R)AN indicates to the SMF when the AN resources onto which a QoS Flow is mapped are released irrespective of whether notification control is configured. (R)AN sends the N2 message (PDU Session ID, N2 SM information) to the AMF. The N2 SM information includes the QFI, User location Information and an indication that the QoS Flow is released. The AMF invokes Nsmf_PDUSession_UpdateSMContext (SM Context ID, N2 SM information).

Action 1f: If the UE supports CE mode B and use of CE mode changes from restricted to unrestricted or vice versa in the Enhanced Coverage Restriction information in the UE context in the AMF and the UE has already established PDU sessions, then the AMF might trigger a PDU session modification to the SMFs serving the UE's PDU sessions and include the extended NAS-SM indication only if use of CE mode B is now unrestricted in the Enhanced Coverage Restriction information in the UE context in the AMF.

Action 2: The SMF may need to report some subscribed event to the PCF by performing an SMF initiated SM Policy Association Modification procedure. The SM Policy Association Modification procedure might be defined as in clause 4.16.5.1 of aforementioned document 3GPP TS 23.502. This action may be skipped if PDU Session Modification procedure is triggered by action 1b or 1d. If dynamic PCC is not deployed, the SMF may apply local policy to decide whether to change the QoS profile.

Action 2a: If redundant transmission has not been activated to the PDU session and the SMF decides to perform redundant transmission for the QoS Flow, the SMF indicates to the UPF to perform packet duplication and elimination for the QoS Flow. If redundant transmission has been activated on the PDU Session, and the SMF decides to stop redundant transmission, the SMF indicates the UPF to release the CN Tunnel Info which is used as the redundancy tunnel of the PDU Session, and also indicates the UPF to stop packet duplication and elimination for the corresponding QoS Flow(s).

Action 2b: The UPF(s) respond to the SMF. If redundant transmission has not been activated to the PDU session and the SMF indicated the UPF to perform packet duplication and elimination for the QoS Flow in action 2a, the UPF allocates an additional CN Tunnel Info. The additional CN Tunnel Info is provided to the SMF. If redundant transmission has not been activated to the PDU Session and the SMF decides to perform redundant transmission for the QoS Flow with two I-UPFs in action 2a, the UPFs allocate CN Tunnel Info. The CN Tunnel Info of each I-UPF is provided to the SMF.

Action 3a: For UE or AN initiated modification, the SMF responds to the AMF through a Nsmf_PDUSession_UpdateSMContext Response. The Nsmf_PDUSession_UpdateSMContext Response might be defined as in aforementioned document 3GPP TS 23.502.

Action 3b: For SMF requested modification, the SMF invokes a Namf_Communication_NiN2MessageTransfer message. The Namf_Communication_NiN2MessageTransfer message might be defined as in aforementioned document 3GPP TS 23.502.

Action 3c: For SMF requested modification due to updated SMF-Associated parameters from the UDM, the SMF may provide the SMF derived CN assisted RAN parameters tuning to the AMF. The SMF invokes Nsmf_PDUSession_SMContextStatusNotify (SMF derived CN assisted RAN parameters tuning) towards the AMF. The AMF stores the SMF derived CN assisted RAN parameters tuning in the associated PDU Session context for this UE.

Action 4: The AMF sends an N2 message ([N2 SM information received from SMF], NAS message (PDU Session ID, N1 SM container (PDU Session Modification Command))) to the (R)AN. The N2 message comprises an indication that specifies the IMS voice support over PS for the UE in the PLMN.

Action 5: The (R)AN may issue AN specific signalling exchange with the UE that is related with the information received from SMF. For example, in the case of a NG-RAN, an RRC Connection Reconfiguration may take place with the UE modifying the necessary (R)AN resources related to the PDU Session or if only N1 SM container is received in action 4 from AMF, RAN transports only the N1 SM container to the UE.

Action 6: The (R)AN may acknowledge N2 PDU Session Request by sending a N2 PDU Session Ack message. The N2 PDU Session Ack message might be defined as in aforementioned document 3GPP TS 23.502.

Action 7: The AMF forwards the N2 SM information and the User location Information received from the AN to the SMF via Nsmf_PDUSession_UpdateSMContext service operation. The SMF replies with a Nsmf_PDUSession_UpdateSMContext Response.

Action 8: The SMF may update N4 session of the UPF(s) that are involved by the PDU Session Modification by sending N4 Session Modification Request message to the UPF.

Action 9: The UE acknowledges the PDU Session Modification Command by sending a NAS message. The NAS message might be defined as in aforementioned document 3GPP TS 23.502.

Action 10: The (R)AN forwards the NAS message to the AMF.

Action 11: The AMF forwards the Ni SM container (PDU Session Modification Command Ack) and User Location Information received from the AN to the SMF via Nsmf_PDUSession_UpdateSMContext service operation. The SMF replies with a Nsmf_PDUSession_UpdateSMContext Response.

Action 12: The SMF may update N4 session of the UPF(s) that are involved by the PDU Session Modification by sending N4 Session Modification Request (N4 Session ID) message to the UPF. For a PDU Session of Ethernet PDU Session Type, the SMF may notify the UPF to add or remove Ethernet Packet Filter Set(s) and forwarding rule(s).

Action 13: If the SMF interacted with the PCF in action 1b or action 2, the SMF notifies the PCF whether the PCC decision could be enforced or not by performing an SMF initiated SM Policy Association Modification procedure. The SM Policy Association Modification procedure might be defined as in clause 4.16.5.1 of aforementioned document 3GPP TS 23.502. If SMF received a Port Management Information Container from either UE or UPF, then SMF provides the Port Management Information Container and the port number of the related port to the PCF in this action.

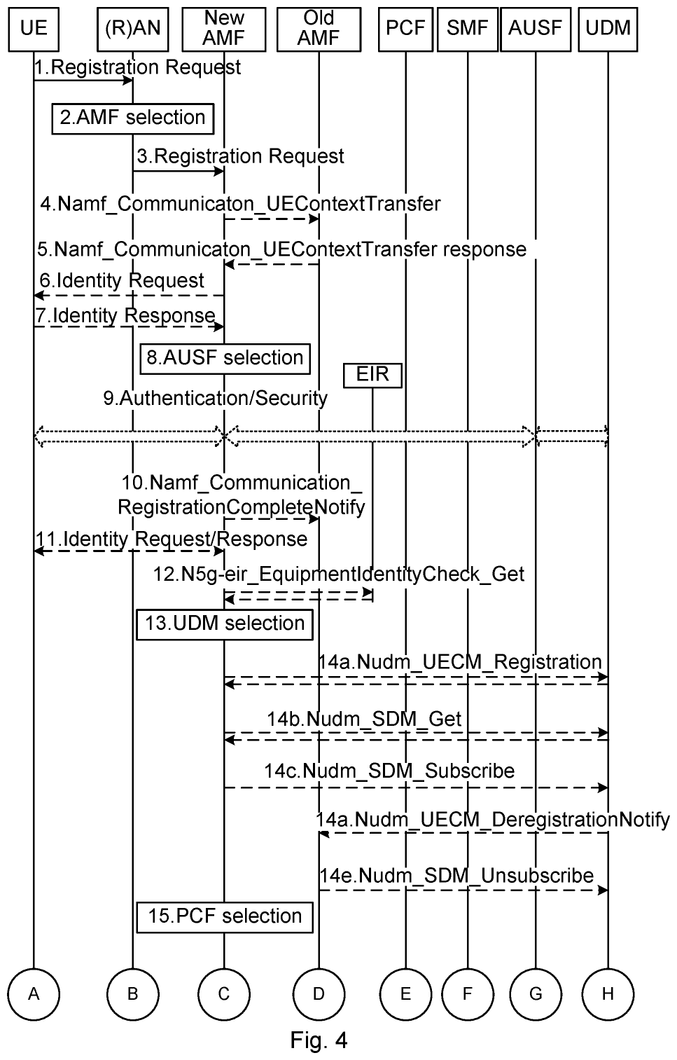

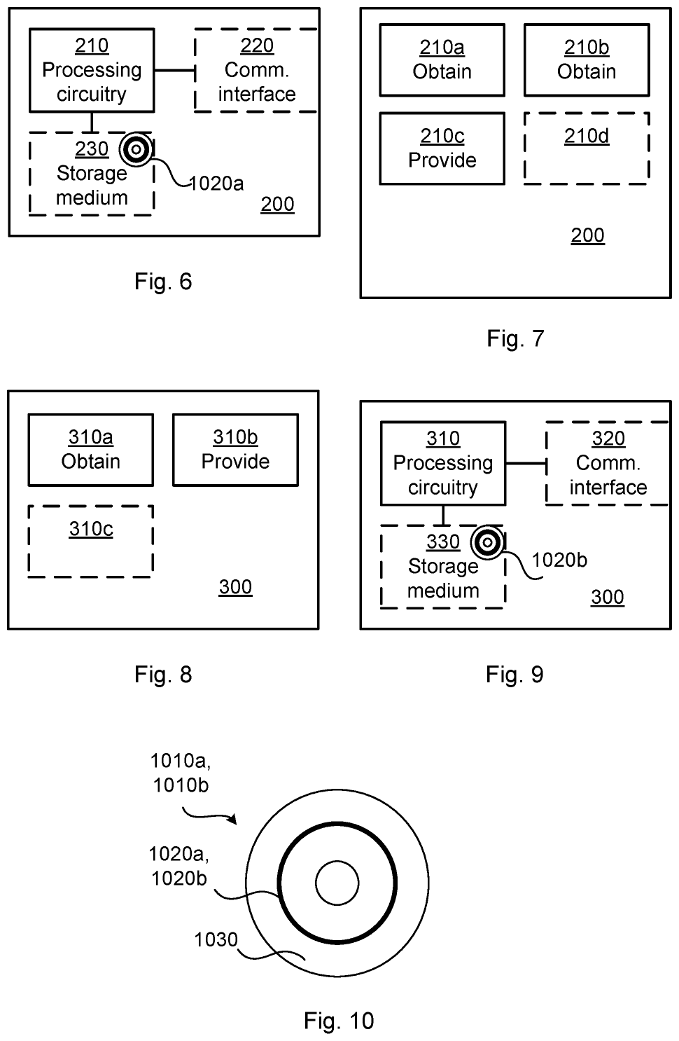

FIG. 6 schematically illustrates, in terms of a number of functional units, the components of an AMF 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product Iowa (as in FIG. 10), e.g. in the form of a storage medium 230. The processing circuitry 210 may further be provided as at least one application specific integrated circuit (ASIC), or field programmable gate array (FPGA).

Particularly, the processing circuitry 210 is configured to cause the AMF 200 to perform a set of operations, or actions, as disclosed above. For example, the storage medium 230 may store the set of operations, and the processing circuitry 210 may be configured to retrieve the set of operations from the storage medium 230 to cause the AMF 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The AMF 200 may further comprise a communications interface 220 for communications with other functions, nodes, and devices of the communication network 100. As such the communications interface 220 may comprise one or more transmitters and receivers, comprising analogue and digital components.

The processing circuitry 210 controls the general operation of the AMF 200 e.g. by sending data and control signals to the communications interface 220 and the storage medium 230, by receiving data and reports from the communications interface 220, and by retrieving data and instructions from the storage medium 230. Other components, as well as the related functionality, of the AMF 200 are omitted in order not to obscure the concepts presented herein.

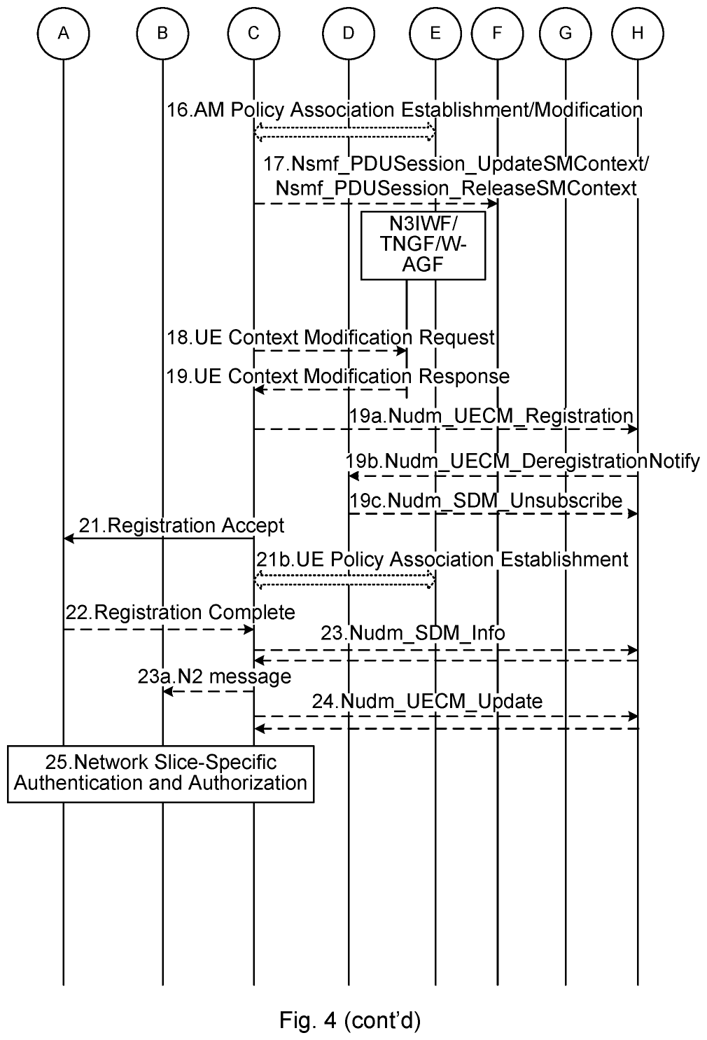

FIG. 7 schematically illustrates, in terms of a number of functional modules, the components of an AMF 200 according to an embodiment. The AMF 200 of FIG. 7 comprises a number of functional modules; an obtain module 210a configured to perform action S102, an obtain module 210b configured to perform action S104, and a provide module 210c configured to perform action S106. The AMF 200 of FIG. 7 may further comprise a number of optional functional modules, as represented by functional module 210d. In general terms, each functional module 210a-210d may be implemented in hardware or in software. Preferably, one or more or all functional modules 210a-210d may be implemented by the processing circuitry 210, possibly in cooperation with the communications interface 220 and/or the storage medium 230. The processing circuitry 210 may thus be arranged to from the storage medium 230 fetch instructions as provided by a functional module 210a-210d and to execute these instructions, thereby performing any actions of the AMF 200 as disclosed herein.

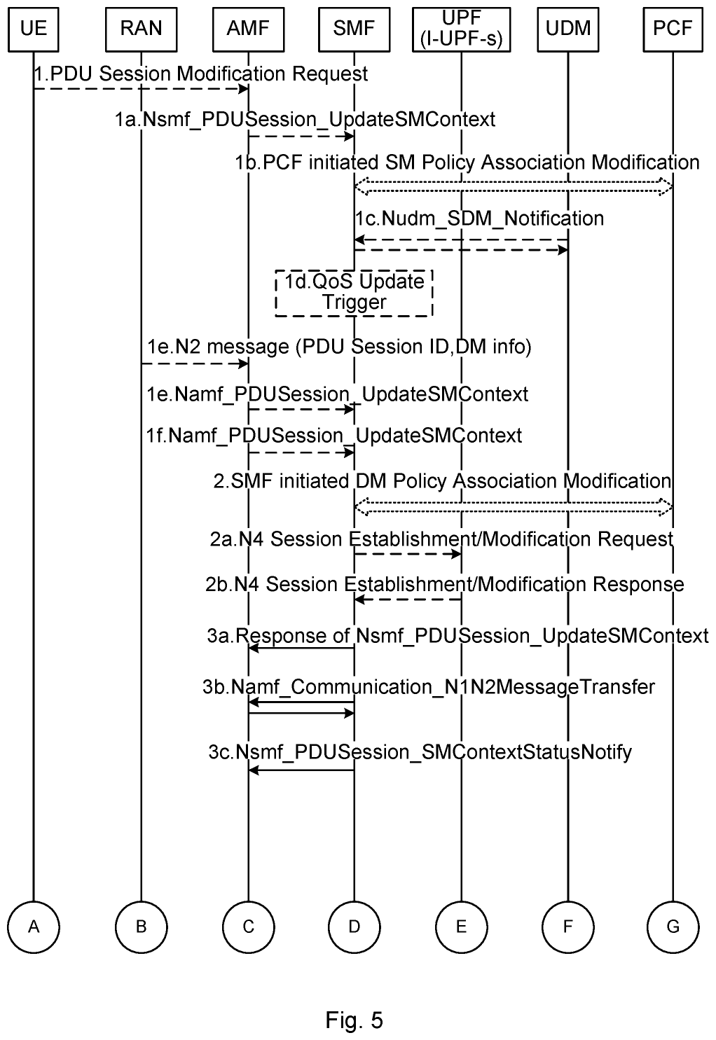

FIG. 8 schematically illustrates, in terms of a number of functional units, the components of a UDM 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product ioiob (as in FIG. 10), e.g. in the form of a storage medium 330. The processing circuitry 310 may further be provided as at least one application specific integrated circuit (ASIC), or field programmable gate array (FPGA).

Particularly, the processing circuitry 310 is configured to cause the UDM 300 to perform a set of operations, or actions, as disclosed above. For example, the storage medium 330 may store the set of operations, and the processing circuitry 310 may be configured to retrieve the set of operations from the storage medium 330 cause the UDM 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The UDM 300 may further comprise a communications interface 320 for communications with other functions, nodes, and devices of the communication network 100. As such the communications interface 320 may comprise one or more transmitters and receivers, comprising analogue and digital components.

The processing circuitry 310 controls the general operation of the UDM 300 e.g. by sending data and control signals to the communications interface 320 and the storage medium 330, by receiving data and reports from the communications interface 320, and by retrieving data and instructions from the storage medium 330. Other components, as well as the related functionality, of the UDM 300 are omitted in order not to obscure the concepts presented herein.

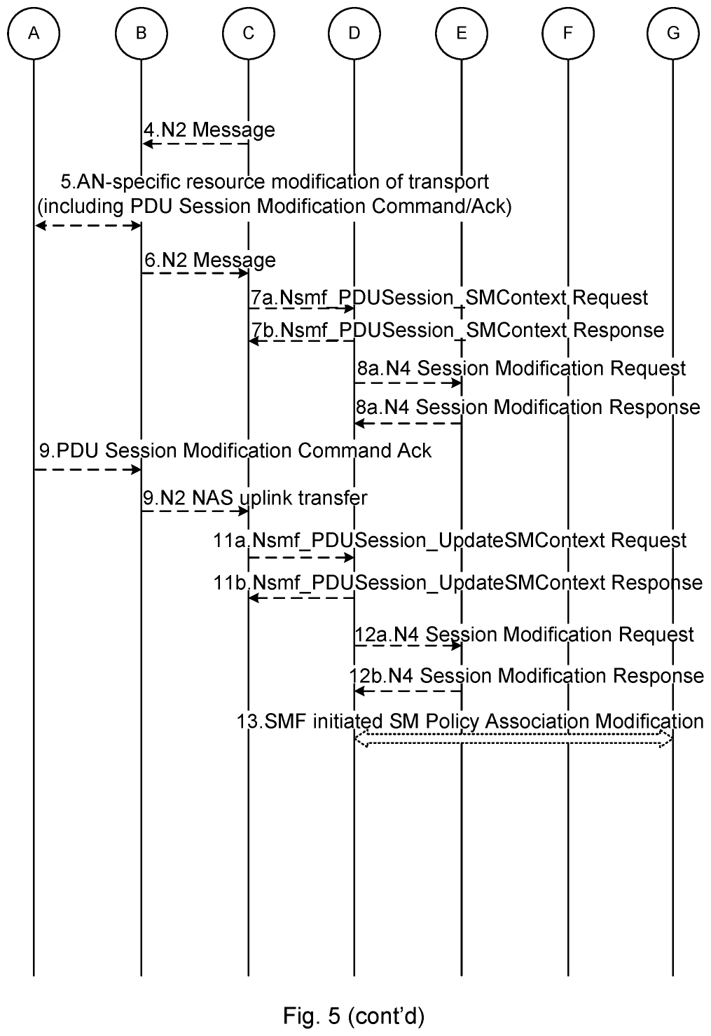

FIG. 9 schematically illustrates, in terms of a number of functional modules, the components of a UDM 300 according to an embodiment. The UDM 300 of FIG. 9 comprises a number of functional modules; an obtain module 310a configured to perform action S202, and a provide module 310b configured to perform action S310b. The UDM 300 of FIG. 9 may further comprise a number of optional functional modules, as represented by functional module 310c. In general terms, each functional module 310a-310c may be implemented in hardware or in software. Preferably, one or more or all functional modules 310a-310c may be implemented by the processing circuitry 310, possibly in cooperation with the communications interface 320 and/or the storage medium 330. The processing circuitry 310 may thus be arranged to from the storage medium 330 fetch instructions as provided by a functional module 310a-310c and to execute these instructions, thereby performing any actions of the UDM 300 as disclosed herein.

Any of the AMF 200 and the UDM 300 may be provided as a standalone device or as a part of at least one further device. For example, the AMF 200 and/or the UDM 300 may be provided in a node of the (radio) access network or in a node of the core network. Alternatively, functionality of the AMF 200 and/or the UDM 300 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the AMF 200 and/or the UDM 300 may be executed in a first device, and a second portion of the instructions performed by the AMF 200 and/or the UDM 300 may be executed in a second device; the herein disclosed embodiments are not limited to any particular number of devices on which the instructions performed by the AMF 200 and/or the UDM 300 may be executed.

Hence, the methods according to the herein disclosed embodiments are suitable to be performed by an AMF 200 and/or the UDM 300 residing in a cloud computational environment. Therefore, although a single processing circuitry 210, 310 is illustrated in FIGS. 6 and 8 the processing circuitry 210, 310 may be distributed among a plurality of devices, or nodes. The same applies to the functional modules 210a-210d, 310a-310c of FIGS. 7 and 9 and the computer programs 1020a, 1020b of FIG. 10.

FIG. 10 shows one example of a computer program product Iowa, 1010b comprising computer readable means 1030. On this computer readable means 1030, a computer program 1020a can be stored, which computer program 1020a can cause the processing circuitry 210 and thereto operatively coupled entities and devices, such as the communications interface 220 and the storage medium 230, to execute methods according to embodiments described herein. The computer program 1020a and/or computer program product Iowa may thus provide means for performing any actions of the AMF 200 as herein disclosed. On this computer readable means 1030, a computer program 1020b can be stored, which computer program 1020b can cause the processing circuitry 310 and thereto operatively coupled entities and devices, such as the communications interface 320 and the storage medium 330, to execute methods according to embodiments described herein. The computer program 1020b and/or computer program product 1010b may thus provide means for performing any actions of the UDM 300 as herein disclosed.

In the example of FIG. 10, the computer program product Iowa, 1010b is illustrated as an optical disc, such as a CD (compact disc) or a DVD (digital versatile disc) or a Blu-Ray disc. The computer program product Iowa, 1010b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1020a, 1020b is here schematically shown as a track on the depicted optical disk, the computer program 1020a, 1020b can be stored in any way which is suitable for the computer program product 1010a, 1010b.

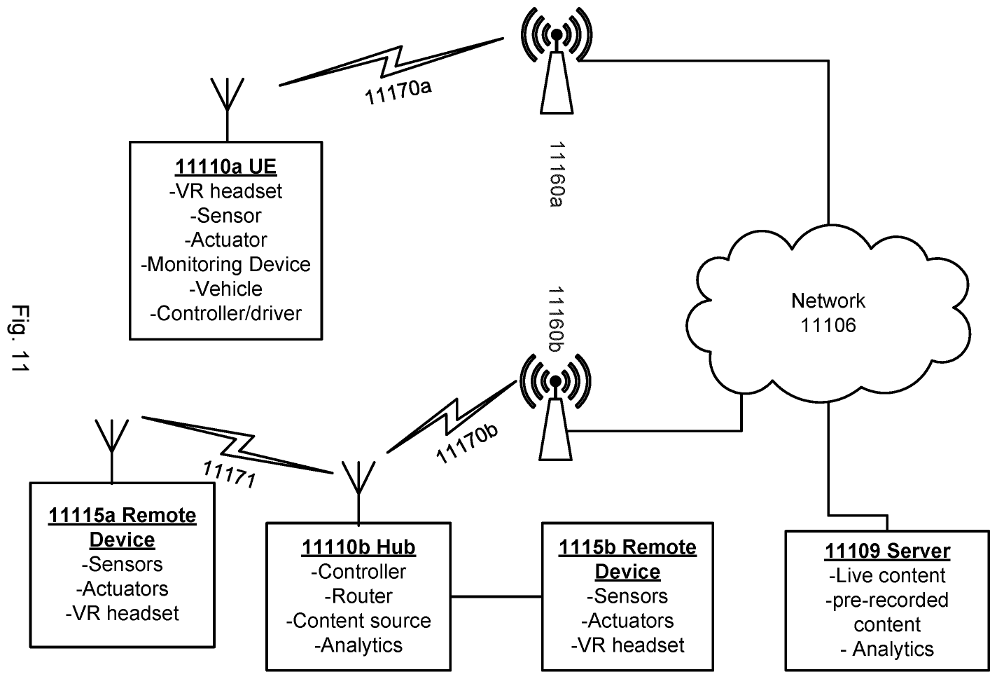

FIG. 11 depicts a wireless network comprising different devices connected, either directly or indirectly, to the wireless network through one or more access network nodes, such as gNBs 11160a and 11160b. In particular, the wireless network includes access network nodes such as gNBs 11160a and 11160b, UE 11110a, hub 11110b, remote devices 11115a and 11115b and server 11109. UE 11110a and hub 11110b may be any of a wide variety of devices capable of communicating wirelessly with gNBs 11160's. Although hub 11110b is referred to as a hub, it may also be considered a UE (with hub functionality) because it is able to communicate wirelessly with gNB 11160b using a standard protocol, for example a wireless standard such as one provided by 3GPP. In fact, each of the devices illustrated in FIG. 11 represent a wide variety of different devices that can be used in different scenarios as discussed in more detail below. Any of these devices which are able to communicate wirelessly with a gNB, eNB or any other similar 3GPP access node may be considered a wireless device or UE.

Looking now at some of the possibilities, UE 11110a may be any of a variety of different devices that are able to wirelessly communicate with gNB 11160a. Some examples, which are listed in FIG. 11, include a virtual reality (VR) headset, a sensor, an actuator, a monitoring device, a vehicle, or a remote controller. These examples are not exhaustive and include therein a wide variety of more specific devices, including a wide range of Internet of Things (IoT) devices. For example, in embodiments where UE 11110a is a VR headset, UE 11110a may be a cell phone that is used with a head mount or it may be a standalone or dedicated VR headset. In some embodiments UE 11110a may be an augmented reality (AR) headset. As an AR or VR headset UE 11110a may be used for entertainment (e.g., gaming, videos, etc.), education/business (e.g., remote conferences, virtual lectures, etc.), medical (e.g., remote diagnostic, patient consultation, etc.), or any other use in which virtual or augmented content may be provided to a remote user. In any of these cases UE 11110a may be receiving content via wireless connection 11170a with gNB 11160a.

As another example, in embodiments where UE 11110a is a sensor or monitoring device, UE 11110a may be a motion, gravitational, moisture, temperature, biometric, speed, door/window open, smoke, fire, volume, flow, or any other type of device that is able to detect or measure one or more conditions. As a sensor UE 11110a may also be able to capture conditions. For example, UE 11110a may capture images if it comprises a camera or sound if it comprises a microphone. Regardless of the type of sensor, UE 11110a may provide an output via wireless connection 11170a to gNB 11160a. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, in embodiments where UE 11110a is an actuator, UE 11110a may be a motor, switch, or any other device that may change states in response to receiving an input via wireless connection 11170a. For example, UE 11100a may be a vibrator that creates vibration to provide a user with haptic feedback. As another example UE 11100a may be a small motor that adjusts the control surfaces of a drone in flight or to a robotic arm performing a medical procedure. As another example, UE 11100a may be a switch that remotely turns on another device, such as a light.

As another example, in embodiments where UE 11110a is a vehicle, UE 11110a may be a drone, car, plane, ship, train, tractor, robot, or any other type of device comprising one or more sensors and/or actuators that may change its locations whether autonomously or at the direction of a user. In such embodiments where UE 11110a is a remotely controlled vehicle, such as a drone, it may receive instructions on movement, actuating, or sensing from a user via wireless connection 11170a and provide location, sensor or video information back to the user via wireless connection 11170a. In such embodiments where UE 11110a is an autonomous vehicle it may receive alerts and other messages from other vehicles and/or infrastructure sensors via wireless connection 11170a as well provide its own telemetry data to others via wireless connection 11170a.

As another example, in embodiments where UE 11110a is a remote control, UE 11110a may be a device dedicated to controlling other devices or a general purpose computer with a program or application that provides control of other devices. UE 11110a may send commands to a remote device via wireless connection 11170a. UE 11110a may also receive feedback, telemetry, or other information from the remote device via wireless connection 11170a. UE 11110a may present this received information to a user who may then issue commands for the remote device. For example, UE 11110a may receive via wireless connection 11170a a video signal from a remote surgical room and then issue commands via wireless connection 11170a to a remote surgical machine that can execute the commands.

While only a single UE 11110a is illustrated in FIG. 11, in practice any number of UEs may be used together with respect to a single use case. For example, a first UE 11110a may be a speed sensor used in a drone which provides the drone's speed information to a second UE 11110a that is a remote control operating the drone. When the user makes changes from the remote control, a third UE 11110a that is an actuator may adjust a throttle on the drone to increase or decrease the speed. Similarly, in the example above, the first (sensor) and third (actuator) UE 11110a's may be a single UE that handles communication for both the speed sensor and the actuators or UE 11 110a may comprise one or more of the above. Similarly, in the example above, a hub, such as hub 11110b, may be used to handle communication between the sensors and actuators and the controller.

Hub 11110b may be any of a variety of different devices that provides wireless access to gNB 11160b for one or more remote devices 11115a. Some examples of different types of hubs are listed in Figure QAA and include a controller, router, content source and analytics. Hub 11110b may include memory to store data (e.g., video, audio, images, buffer, sensor data, file share) that is collected from, or is to be provided to, remote device 11115a. Hub 11110b hub may include a processor, operating system, and server functionality. Hub 11110b may include components for wireless communication to enable wireless connection 11171 to remote device 11115a and/or components for a fixed connection to remote device 11115b. Hub 11110b may also include routing capabilities, firewall capabilities, a VPN-server or VPN-client. Hub 11110b may also allow for a different communication scheme and/or schedule between hub 11110b and remote devices 11115 and between hub 11110b and network 11106.

As one example, hub 11110b may be a broadband router enabling direct or indirect access to network 11106 for remote device 11115a. In certain embodiments, hub 11110b may facilitate communication between remote devices 11115a and 11115b. This may be done with, or without, the communications passing through network 11106. In some embodiments, hub 11110b may simply forward the data from remote device 11115a or 11115b to network 11106. In some embodiments, hub 11110b may first filter, buffer, store, analyze or collate the data from remote device 11115a or 11115b before sending on the data to network 11106 or another remote device. Similarly, the data from network 11106 may pass directly through hub 11110b or it may first be processed by hub 11110b on the way to remote device 11115a or 11115b.

As another example, hub 11110b may be a controller that sends commands or instructions to one or more actuators in remote device 11115a. The commands or instructions may be received from a second remote device 11115b, from gNB 1116a or by executable code, script or process instructions in hub 11110b.

As another example, hub 11110b may be a collection place for data from one or more remote devices 11115a and/or 11115b. For example, remote devices 11115a and/or 11115b may be a sensor, a camera, measurement equipment, or any other type of device discussed herein that may provide output or receive input. Hub 11110b may act as a temporary storage for data from, for example remote device 11115b and, in some embodiments, may perform analysis, or other processing on the data. Hub 11110b may have a constant/persistent or intermittent connection to gNB 1116a.

As another example, hub 1110b may be a content source. For example, when remote device 11115a is a VR headset, display, loudspeaker or other media delivery device, hub 11110b may retrieve VR assets, video, audio, or other media via gNB 11160b which it then provides to remote device 11115a either directly, after some local processing, and/or after adding additional local content.

Remote device 11115a may be any of a variety of different devices, for example, remote device 11115a may be a device comprising one or more of sensors, actuators, and/or a screen. Remote device 11115a may alternatively be a VR (or AR) headset, a Machine-2-Machine (M2M) device, an IoT device, an internet of Everything (IoE) device, or any other type of device which is capable of accessing a communication network wirelessly via a hub or a device capable of acting as a hub, which in the present context comprise providing network access to a device which is not able to communicate directly with communication network 11106 via gNB 11160a or 11160b. In some scenarios, remote device 11115a may be able to establish a wireless connection with gNB 11160a or 11160b yet nonetheless still connects via hub 1110b. Remote device 11115b may be similar to remote device 11115a in most respects except that it has a wired connection to hub 11110b rather than a wireless connection, such as wireless connection 11171.

The gNBs 11160a and 11160b may provide various wireless devices such as UE 11110a and hub 11110b with wireless access to network 11106. Network 11106 may connect the various devices illustrated in FIG. 11 including server 11109 which may host a variety of applications such as live and pre-recorded content, data collection services such as retrieving and compiling data on various ambient conditions detected by a plurality of remote devices 11115a, 11115b or UE 11110a, analytics functionality, social media, functions for controlling or otherwise interacting with remote devices, functions for an alarm and surveillance center, or any other such function done by a server. For example, factory status information may be collected and analyzed by server 11109. As another example, server 11109 process audio and video data which may have been retrieved from UE 11110a for use in creating maps. As another example, server 11109 may collect and analyze real-time data to assist in controlling vehicle congestion (e.g., controlling traffic lights). As another example, server 11109 may store surveillance video uploaded by remote device 11115b via hub 11110b. As another example, server 11109 may store media content such as video, audio, VR, or AR which it can broadcast, multicast or unicast to remote devices such as UE 11110a or remote device 11115a. As other examples, server 11109 may be used for energy pricing, for remote control of non-time critical electrical load to balance power generation needs, location services, presentation services (such as compiling diagrams etc. from data collected from remote devices), or any other function of collecting, retrieving, storing, analyzing and/or transmitting data.

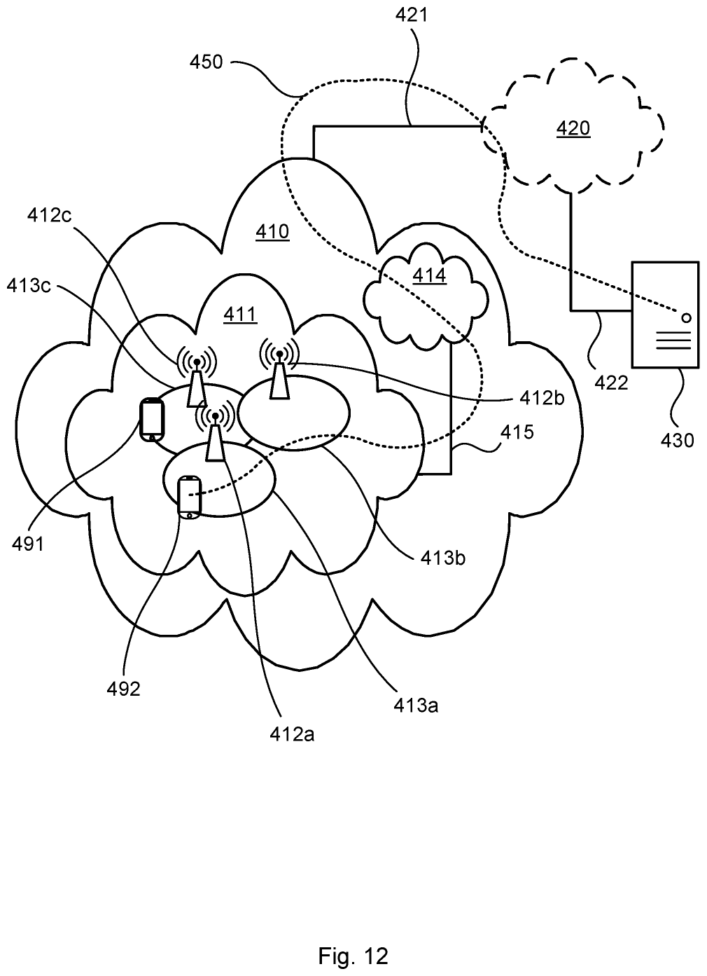

FIG. 12 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as (R)AN 134 in FIG. 1, and core network 414, such as defined by functions 110, 112, 114, 116, 300, 118, 120, 122, 124, 200, 126, 128, 130, 136 in FIG. 1. Access network 411 comprises a plurality of (radio) access network nodes 412a, 412b, 412c, such as NBs, eNBs, gNBs (for example located in the (R)AN 134 of FIG. 1) or other types of wireless access points, each defining a corresponding coverage area, or cell, 413a, 413b, 413c. Each (radio) access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the UE 132 of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 12 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

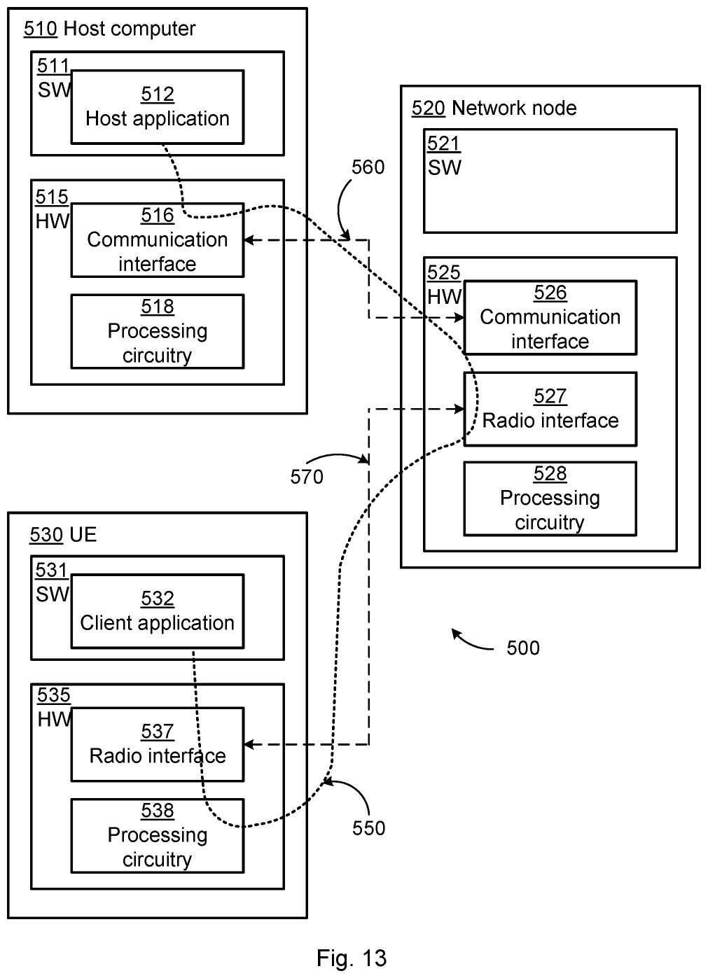

FIG. 13 is a schematic diagram illustrating host computer communicating via a (radio) access network node with a UE over a partially wireless connection in accordance with some embodiments. Example implementations, in accordance with an embodiment, of the UE, (radio) access network node and host computer discussed in the preceding paragraphs will now be described with reference to FIG. 13. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the UE 132 of FIG. 1. In providing the service to the remote user, host application 512 may provide user data which is transmitted using OTT connection 550.

Communication system 500 further includes (radio) access network node 520 provided in a telecommunication system and comprising hardware 525 enabling it to communicate with host computer 510 and with UE 530. The (radio) access network node 520 could be part of the (R)AN 134 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 13) served by (radio) access network node 520. Communication interface 526 may be configured to facilitate connection 560 to host computer 510. Connection 560 may be direct or it may pass through a core network (not shown in FIG. 13) of the telecommunication system and/or through one or more intermediate networks outside the telecommunication system. In the embodiment shown, hardware 525 of (radio) access network node 520 further includes processing circuitry 528, which may comprise one or more programmable processors, application-specific integrated circuits, field programmable gate arrays or combinations of these (not shown) adapted to execute instructions. (radio) access network node 520 further has software 521 stored internally or accessible via an external connection.

Communication system 500 further includes UE 530 already referred to. Its hardware 535 may include radio interface 537 configured to set up and maintain wireless connection 570 with a (radio) access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, (radio) access network node 520 and UE 530 illustrated in FIG. 13 may be similar or identical to host computer 430, one of network nodes 412a, 412b, 412c and one of UEs 491, 492 of FIG. 12, respectively. This is to say, the inner workings of these entities may be as shown in FIG. 13 and independently, the surrounding network topology may be that of FIG. 12.

In FIG. 13, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and (radio) access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to (radio) access network node 520. Such procedures and functionalities may be known and practiced in the art. In certain embodiments, measurements may involve proprietary UE signaling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. An AMF for indicating IMS voice support over PS for a UE in a PLMN, the AMF comprising processing circuitry, the processing circuitry being configured to cause the AMF to:
obtain a trigger for the AMF to indicate IMS voice support over PS for the UE in the PLMN;
obtain information of IMS voice support over PS for the UE in the PLMN; and
provide, based on the information, an indication to a radio access network serving the UE in the PLMN, wherein the indication specifies the IMS voice support over PS for the UE in the PLMN.

2. The AMF of claim 1, wherein, according to the information, at least one of EPS fallback and VoNR is supported for the UE in the PLMN.

3. The AMF of claim 1, wherein
the indication specifies i) whether EPS fallback is supported or not for the UE in the PLMN and/or ii) whether VoNR is supported or not for the UE in the PLMN, or
the indication specifies that neither EPS fallback nor VoNR is supported for the UE in the PLMN.

4. (canceled)

5. (canceled)

6. The AMF of claim 1, wherein the trigger is a registration request message obtained from the radio access network during network registration of the UE.

7. The AMF of claim 1, wherein the trigger is a Namf_Communication_N1N2Message_Transfer message obtained from an SMF during a PDU session modification procedure for the UE.

8. The AMF of claim 1, wherein the information is obtained as Access and Mobility Subscription data, or SMF Selection Subscription Data, in a Nudm_SDM_Get response message from a UDM.

9. The AMF of claim 5, wherein
the information is obtained as Access and Mobility Subscription data, or SMF Selection Subscription Data, in a Nudm SDM Get response message from a UDM, and
the information is obtained from a UDM by the UDM not including an IMS DNN in a list of subscribed DNNs that is provided to the AMF.

10. (canceled)

11. The AMF of claim 1, wherein
the information is obtained as configuration from a memory of the AMF, and the configuration is defined by roaming agreement information, or
the information is obtained as configuration from a memory of the AMF, and the configuration is defined by subscriber information.

12. The AMF of claim 11, wherein the configuration is provided as a list of PLMNs subject to apply EPS fallback and/or a list of PLMNs subject to apply VoNR.

13. The AMF of claim 11, wherein the configuration is provided as a list of IMSI series of PLMNs subject to apply EPS fallback and/or a list of IMSI series of PLMNs subject to apply VoNR.

14. The AMF of claim 1, wherein
the trigger causes the AMF to obtain the information, or
the AMF obtains the information before obtaining the trigger.

15. (canceled)

16. The AMF of claim 1, wherein
the indication is provided to the radio access network in a registration accept message during network registration of the UE, or
the indication is provided to the radio access network in an N2 message during a PDU session modification procedure for the UE.

17. (canceled)

18. The AMF of claim 1, wherein the PLMN is a visited PLMN of the UE.

19. (canceled)

20. A UDM for enabling indicating IMS voice support over PS for a UE in a PLMN, the UDM comprising processing circuitry, the processing circuitry being configured to cause the UDM to:
obtain a trigger from the AMF for the UDM to indicate IMS voice support over PS for the UE in the PLMN; and
provide information to the AMF of IMS voice support over PS for the UE in the PLMN.

21. The UDM of claim 20, wherein
the trigger is obtained in a Nudm_SDM_Get request message from the AMF and
the information is provided as Access and Mobility Subscription data, or SMF Selection Subscription Data, in a Nudm SDM Get response message to the AMF.

22. (canceled)

23. The UDM of claim 20, wherein the information is provided by the UDM not including an IMS DNN in a list of subscribed DNNs to the AMF.

24. (canceled)

25. (canceled)

26. A method for indicating IMS voice support over PS for a UE in a PLMN, the method being performed by an AMF of the PLMN, the method comprising:
obtaining a trigger for the AMF to indicate IMS voice support over PS for the UE in the PLMN;
obtaining information of IMS voice support over PS for the UE in the PLMN; and
providing, based on the information, an indication to a radio access network serving the UE in the PLMN, wherein the indication specifies the IMS voice support over PS for the UE in the PLMN.

27. A method for enabling indicating IMS voice support over PS for a UE in a PLMN, the method being performed by a UDM of the PLMN, the method comprising:
obtaining a trigger from the AMF for the UDM to indicate IMS voice support over PS for the UE in the PLMN; and
providing information to the AMF of IMS voice support over PS for the UE in the PLMN.

28. A non-transitory computer readable storage medium storing a computer program for indicating IMS voice support over PS for a UE in a PLMN, the computer program comprising computer code which, when run on processing circuitry of an AMF, causes the AMF to perform the method of claim 26.

29. A non-transitory computer readable storage medium storing a computer program for enabling indicating IMS voice support over PS for a UE in a PLMN, the computer program comprising computer code which, when run on processing circuitry of a UDM, causes the UDM to perform the method of claim 27.

30. (canceled)
